(19) United States
(12) Patent Application Publication
(10) Pub. No.: US 2015/0127402 A1
(43) Pub. Date: May 7, 2015

(54) METHOD AND SYSTEM FOR STRUCTURING INFORMATION BACKGROUND OF THE INVENTION

(71) Applicant: GIGA-BYTE TECHNOLOGY CO.,LTD., New Taipei City (TW)

(72) Inventor: Kuang Hua Pai, New Taipei City (TW)

(73) Assignee: GIGA-BYTE TECHNOLOGY CO.,LTD., New Taipei City (TW)

(21) Appl. No.: 14/073,700

(22) Filed: Nov. 6, 2013

(51) Int. Cl. G06Q 10/10

(52) U.S. Cl. CPC G06Q 10/103
USPC 705/7.15; 705/301

(57) ABSTRACT

A method and system is adapted for structuring communication information, so as to form a plurality of working groups which composed of many members. The method comprises: establishing a working group by a administrator; sending a message from a member of the working group, wherein the message contains at least one title and content; receiving the message by the other members of the working group; choosing the message on a mail list by any members of the working group; clicking a switching function to integrate the message into the working group; providing the members with access authority; providing at least one third party with authority to only read the messages. In addition, the system comprises an information-transmitting module, information-retrieving module, information-switching module, time-counting module, information-recording module and alerting module.

### BACKGROUND OF THE INVENTION

1. Field of Invention

The present invention relates to a method and a system for information management, and more particularly, a method and a system for structuring information.

2. Related Art

Online communication has become the primary mode of conducting work across different geographic spaces. However, the lack of structure in online communication creates challenges for users who need to effectively communicate and utilize the information shared via the web. Due to the structure of conventional workgroup platforms, challenges may emerge when copying, reusing and managing work within a workgroup. Specifically, existing communication platforms feature the following shortcomings:
(1) Unclassified messages: message sent from one individual to another cannot be presented efficiently and the communication (for example, email, instant messages, voice messages, etc.) cannot be integrated and classified effectively, thus restricting efficient sharing of the information in a group.
(2) Complicated project management: work-oriented project communication, project management with inheritance, and operational and regulatory complexity, resulting in only the form of job management, and cannot perform its true function.
(3) The receiver must constantly forward and share messages with the group manually in order to keep workgroup participants up-to-date on the project.
(4) The assignment of work presented in message cannot be tracked.
(5) Non learning system: The traditional systems lack an ability to learn from users and require manual command input in order to perform its functions. These systems lack an ability to analyze, calculate and summarize data.

### SUMMARY OF THE INVENTION

To resolve the problems identified above, this submission proposes a structured communication platform, which will enhance the efficiency of workgroups. Structured communication is understood to be a process that combines various communications into a single interface, integrating email, instant message, voice conferencing and etc. into a single platform, to establish a communication platform that is able to categorize the various messages sent between the users. This platform is the subject of the present invention.

Disclosed in the present invention is a method of structuring information, adapted for structuring communication information to form a plurality of working groups, which are composed of many members. The method comprises Step S1: establishing a working group by an administrator; Step S2: sending a message from a member of the working group to other members, wherein the message contains at least one title and content; Step S3: receiving the message by the other members of the working group; Step S4: choosing the message on a mail list by any members of the working group; Step S5: clicking a switching function to classify the message into appropriate working group; Step S6: providing the members with access authority; and Step S7: providing at least one third party with authority to only read the specified messages.

Additionally, the proposed platform further comprises the steps relevant to the project management: Step S8; sending notifications to the members responsible for the task automatically. The notifications indicates the deadline of the task and this message is sent out before a given time of the deadline; Step S9: sending notifications to the members responsible for the task automatically when the task is completed; step S10: adding and deleting the number of members of the working group by the administrator; and Step S11: the administrator may carry out the task assignment and manage members of the working groups through an assist list. It should be understood that, there is no necessity for these steps to proceed in a sequence from Steps S8 to S11. In other words, as long as the steps S1-S7 are executed, Steps S8-S11 may proceed in any order to suit the needs of the administrator.

In the present invention is a system of structuring information, computed on data processing equipment and adapted for structuring communication information to form a plurality of working groups, which are composed of many members. The system comprises an information-transmitting module, which transmits and receives a plurality of messages; an information-retrieving module, which retrieves a plurality of messages complying with specific rules; an information-switching module, which is designed to integrate the message into the working group; a time-counting module, which is provided for deadline control of the specific message of the working group; an information-recording module, for the analysis process of the specific message of the working group; and an alerting module, for sending notification to the members responsible for the specific message automatically. Such notification function indicates the deadline of the tasks, with the messages sent out before of the specified deadline.

There are several advantages of classifying and integrating messages into various working groups in the present invention. (1) Convenience for enquiries and links: history of messages is easier to inquire through the platform of working groups and the messages may be connected through the concept of project management, and the communicated messages may be presented completely. (2) Communication convenience: the platform may make the messages more convenient and transitive. (3) Simplicity and flexibility: generally, in the execution of project management, the permissions control must be assigned manually. The invention integrates the technology of project management to execute work communication, so as to increase the simplicity and flexibility of communication. (4) Communication integrity: the messages are not structured traditionally, such as for the management of structured message through the management technology of project management in the present invention. All kinds of messages may be managed efficiently to keep the integrity of communication. (5) Communication automation: The traditional systems lack an ability to learn from users and require manual command input in order to perform its functions. These systems lack an ability to analyze, calculate and summarize data. The invention integrates the system-agent communication model of human-machine interface to extract the complete information of message. This will not only allow for intelligent classification of the messages into different folders, but will also integrate them into appropriate working groups for the effective management and coordination.

### BRIEF DESCRIPTION OF THE DRAWINGS

FIG. 1 is a flow chart of the method of structuring information according to an embodiment of the present invention;

FIG. 2 is a schematic diagram of the working group according to the embodiment of the present invention;

FIG. 3 is a schematic diagram of the data processing equipment according to the embodiment of the present invention;

FIG. 4 is a schematic diagram of the system of structuring information according to the embodiment of the present invention.

### DETAILED DESCRIPTION OF THE INVENTION

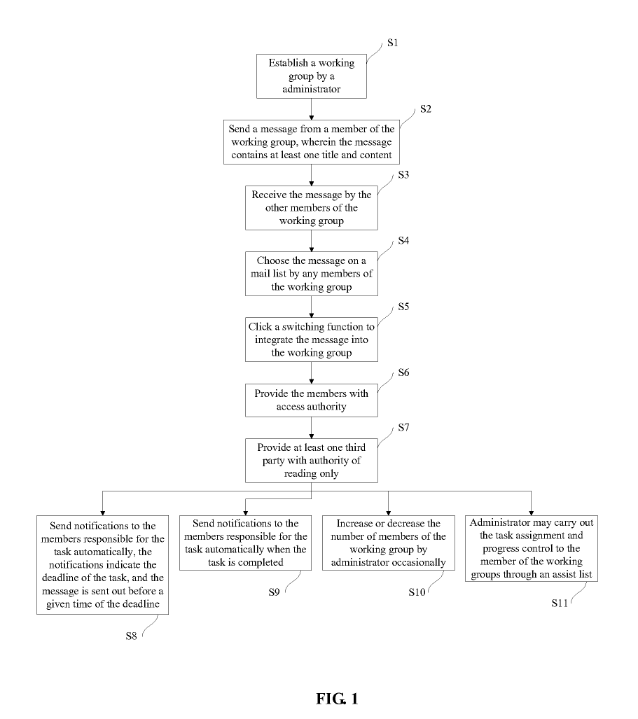

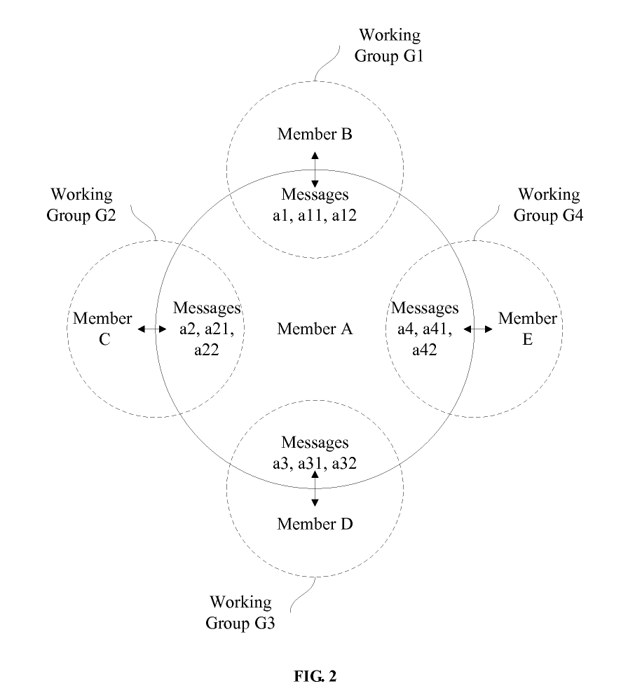

FIG. 1 and FIG. 2 respectively depict a flow chart of the method of structured information and a schematic diagram of the working group according to an embodiment of the present invention. Described first herein, conventional project management systems provide structured work platforms. Although helpful for management, settings of such systems are complicated, making it difficult to apply them in practice. For example, “FaceBook”, has become inseparable from daily life. It allows users to share information and communicate within groups created by an administrator. However, project management techniques that exist in the current social networks may not meet the demand of the business community when group members engage in a project management-oriented tasks.

Comparatively, the main technical features of the invention are operated through a single button, making it easy for any communicated information to be transformed into a working group and provide a communication platform to the members of the working group, in addition to simplifying the management of the information and task assignment.

To achieve these benefits, the present invention adapts the concept of the online group to business management to form a working group, through parallel communication, combining the communication information of work and the concept of project management to attain structured communication and management of correspondences. This communication platform allows simple message history retrieval, and connects all communication messages, allowing, for example, to present topics in the same working group in their entirety. As describe above, this method of structuring information is established by the creation of a working group by an administrator. The working group operated under the proposed platform will allow for parallel communication, and may recreate the characteristics of structured communication in the physical world by integration all community activities (E-mail, instant message, voice conferencing, etc.) into a single interface, thus establishing a structuring communication platform.

Step S2 and S3 involve sending a message from a member of the working group, wherein the message contains at least one title and content and receiving the message by the other members of the working group. After the working group is established, as depicted in FIG. 2, member A and member B may form a working group G1, Member A and member C may form a another working group G2, Member A and member C may form a another working group G3, and member A and member E may form a another working group G4. In other words, member A may be any one person of an enterprise and everyone has the opportunity to share the communicated message with anyone in the enterprise. For example, when message a1 is delivered between member A and member B, member A may establish a working group G1 belongs to member A and member B, at the same time member A is the administrator of working group G1, but if the working group G1 is established by member B, the administrator of working group G1 will be member B. Similarly, when message a2 is sent between member A and member C, member A may establish a working group G2 belongs to member A and member C.

Step S4 and S5 involve choosing the message from a mail list by any member of the working group and clicking a switching function to integrate the message into the working group. In other words, in the case of member A, the messages with project management designation are always being sent and received by member A in timeline view, for example message a11, a12, a21, a22, a31, a32, a41, a42 (message number do not have this affiliation), and the receiver, title and content of the message may have relevance or not, for example, the relevance of message a11 and a12 is the receiver of the both messages is member B. Therefore, messages a11 and a12 are vested in working group G1. However, in member A's point of view, not all the messages shall be vested in working group G1 as long as the message is member B-related. In this example, messages a11 and a12 may not only have relevance to the receiver. While there is relevance in the title and content of messages, for example, message a11 and a12 are both related to the task of pattern application, and there is another message not pattern-related between member A and B. This message shall be rerouted into another working group but not in working group G1. It should be understood that, for convenience of description herein, although the illustrations are based on two members in each working group, actually the number of member in each working group may be unlimited.

Specifically, member A or member B of working group G1 may first choose and click on messages a11 and a12 on their own message lists respectively, and then click the switching function to integrate the two messages into the working group G1. Similarly, there are messages a2, a21 and a22 in working group G2, messages a3, a31 and a32 in working group G3 and messages a4, a41 and a42 in working group G4. Additionally, if the member A sends any message, the message shall be allocated into a specific working group automatically, according to specific rules set by the system, wherein the specific rules are determining based on the receiver, title and content of the message. Different from the well-known conception of project management, in the present invention it is easy to classify the messages into working groups through a switching function. Thus, complicated settings, working group names, schedule planning, etc. are not needed. Finally, if the message is determined not belong to any working group according to the specific rules of the system, user is able to select the message and click the switching function, establishing a new working group according to the feature of the message by system by the administrator.

As described above, according to member A's point of view, there are a plurality of messages in each of working group G1-G4, such that all members of working group G1-G4 may parallel browse the task assignment and progress tracking of messages. In other words, under the existing technology, messages of member A may not be classified automatically, meaning that all the messages a1-a42 must be classified according to the title or contents manually. In the present invention, through the structured way of working group, related message and topic may be browsed in parallel in the same working group to control different topics and the message history may be grasped easier. Furthermore, according to member A's point of view, messages are related to member B as long as they are related to working group G1, such that member A may grasp any message related to member B as long as working under working group G1. In addition, at the same time of integrating message into working group, the receiver of message may be set as a member by default. Default member will be selected as the receiver by system when message is sent again, thus saving the complicated step of choosing and setting members.

Furthermore; taking working group G1 as an example, under the same working group platform, there is deadline control in each of messages a1-a12, such that the complete schedule of message which may be depicted by using Gantt chart. Alternatively, each message is presented as a task, member A and B of working group G1 may update state of task through the platform of working group G1, wherein the execution of the task is categorized as ongoing, completed or finished.

Steps S6 and S7 are providing the members with access authority, and delegate at least one third-party with authority to only read the messages. For project management of enterprise, using group member G1 as an example, members A and B have the authority of accessing the messages, and may provide another entity with the authority to only read messages of the working group G1, for example member C. As a result, members not belonging to the working group may also have the opportunity to view the messages concerning the task of the working group. Furthermore, the access authority is implemented according to the conditions of project management of enterprises; there is different Proprietary Information Protection Policy of different projects.

The method of structuring information further comprises step S8 that is sending notifications to the members responsible for the task automatically. The notifications indicate the deadline of the task, and the message is sent out before a given time of the deadline. Using the working group G1 as an example, there is a task owner in each message, such as the task owner of message a1 is member A, while the task owner of message a1 is member B. The notification shall be sent to task owner by system before the deadline of each task, to attain the effectiveness of project schedule control. Step S9 involves sending notifications to the members responsible for the task automatically when the task is completed. Notifications shall be sent to the members responsible for the task automatically while the corresponding message of task is marked as completed. For example, if the message a1 is marked as completed by member B of working group G1, notification will be sent to member A (the person in charge of the task) by the system. Step 10 allows for increase or decrease the number of members in the working group by the administrator. There is a corresponding administrator of each working group, under different tasks. The administrator may have the authority of increasing or decreasing the number of members of the working group. In Step S11 the administrator may carry out the task assignment and progress control through an assist list. The user interface of the working group further comprises an assist list in the present invention, allowing the administrator to carry out the task assignment and progress control to any member of the working group. In other words, under the same platform of working group G1, the administrator member A may carry out progress control and task assignment to member B.

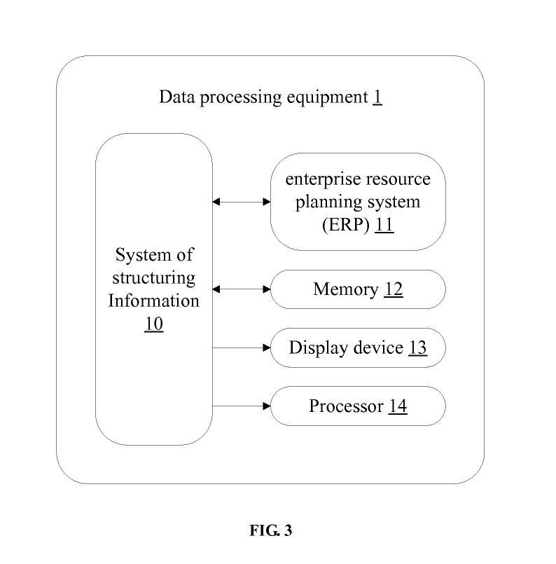

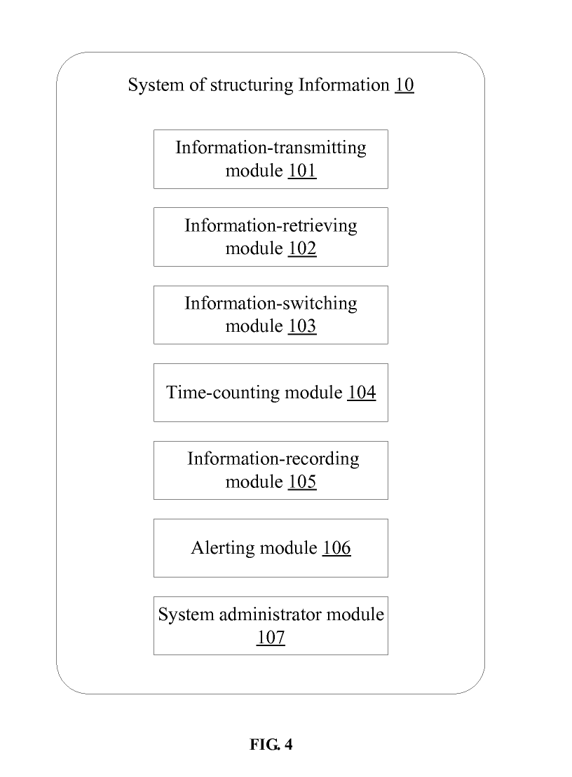

FIG. 3 and FIG. 4 respectively depict the schematic diagram of the data processing equipment and the conceptual diagram of the system of structuring information according to the embodiment of the present invention. As the figures show, a system of structuring information 10, computes on a data processing equipment 1 and is adapted for structuring communication information to form a plurality of working groups composed of many members. The features of the working group platform comprise: collection of mail and other messaging, archival, instant messaging and calendar. Wherein the data processing equipment 1, for example, may be a personal computer or an application server, and comprise at least an enterprise resource planning system 11 (ERP), a memory 12, a display device 13 and a processor 14. Further description, from a generally personal computer to an application server mostly used by enterprise, may be used for the system of structuring information of the present invention.

In greater detail, the system of structuring information 10 comprises an information-transmitting module 101, an information-retrieving module 102, an information-switching module 103, a time-counting module 104, an information-recording module 105 and an alerting module 106. The information-transmitting module, is used for transmitting and receiving a plurality of messages; an information-retrieving module, is used for retrieving a plurality of messages complying with a specific rule; an information-switching module, is used for integrating the messages into the working group; an time-counting module, is used for process and analysis the deadline control of the specific messages of the working group; an information-recording module, is used for process and analysis the state of the specific messages of the working group; an alerting module, for sending notification to the members responsible for the specific messages automatically, the notifications indicate the deadline of the tasks, and the messages are sent out before a given time of the deadline.

As shown in FIG. 1-2, member A may form several working groups related to member A. The plurality of message in each working group will be transmitted between the member A and receivers through the information-transmitting module of the present invention. Furthermore, member A will send and receive a number of messages everyday, such as messages a1-a42, an information-retrieving module may retrieve a plurality of message complying with a specific sorting rule based on the receiver, title and content of the messages. For example, messages a1, a11 and a12 are all related to member A, while messages a2, a21 and a22 are all related to member C. And then, specific messages will be integrated into appropriate working groups by the information-switching module as long as any member chooses the message and clicks the switching function. For example, messages a1, a11 and a12 are integrated into working group G1, while a2, a21 and a22 are integrated into working group G2, and so on, such that the members of the working groups may parallel browse the task assignment and progress tracking of the message.

Under the same platform of the working group, taking working group G1 as an example, each of messages a1-a12 contain deadline control and the time-counting module is used for process and analysis of the deadlines relevant to the messages a1-a12 of the working group G1. The working group G1 may depict the complete schedule of messages a1-a12 by using Gantt chart. Each message is presented as a task, member A and B of working group G1 may update state of the task through the platform of working group G1, wherein the task may be classified as ongoing, completed or finished. The information-recording module is used for processing and analysis the state of the specific message a1-a12 of the working groups. Notifications shall be sent to the members responsible for the messages a1-a12 automatically, while the state of the specific messages a1-a12 are marked as completed. For example, if the message a1 is marked as completed by member B of working group G1, then notification will be sent to member A (the person in charge of the task) by system, and member A may fully understand the state of task. Additionally, taking the working group G1 as an example and owner of message al as member A, the notification shall be sent to task owner by system before the deadline of each task, to attain the effectiveness of project schedule control, and the alerting module is for sending notification to the members responsible for the specific message automatically. These notifications indicate the deadline of the task, and the message is sent out before a given time of the deadline.

The system of structuring information further comprises a system administrator module 107 which grants authority to providing the members with access to the messages and allows at least one party to only read the messages; and a project revising device, for carrying out the task assignment and progress control of members.

Through intelligent classification, the system may learn how to classify the messages into relevant working groups, reducing the time required for people to classify correspondences classification, thus improving the working efficiency of users. Additionally, to avoid the collection of unclassified mail message and track their completion progress, the messages may be classified into related working group, and assigned control. The control and assignment of task is done through the concept of project management, to improve the efficiency of work messages. At the same time, member joining the working group may have the authority to viewing the history and files in the messages. Other members may be assigned authority to edit, add new work items under working group. This automated permission control will allow for efficient management of all group members to increase the simplicity and flexibility of communication. Members of working group may further create different topics through new message and the replied messages attached to the same topic will be viewed as a whole, thus attaining the effective structure of messages.

The example disclosure, as describe above, in the present invention is not limiting the invention. Any person familiar with the relevant skills, without departing from the spirit and scope of the invention, may make changes to the invention to account for different work group needs. We respectfully submit that the patent protection of this invention should depend on the definition of Patentability of the instructions.

What is claimed is:

1. A method of structuring information, adapted for structuring communication information to form a plurality of working groups, which are composed of a plurality of members, wherein the method comprising:
establishing a working group by a administrator;
sending a message from one of the member of the working group, wherein the message contains at least one title and content;
receiving the message by the other members of the working group;
choosing the message on a mail list by the members of the working group;
clicking a switching function to integrate the message into the working group;
providing the members with access authority; and
providing at least one third party with authority to only read the messages.

2. The method of structuring information of claim 1, wherein the working groups further comprise a plurality of message, the title and the content of the messages are associated, the members of the working group parallel browsing the task assignment and progress tracking of the messages.

3. The method of structuring information of claim 2, wherein all of the messages further comprise a deadline control respectively, the complete schedule of the messages of the working group are depict by using Gantt chart.

4. The method of structuring information of claim 2, wherein all of the messages are tasks, and the members of the working group update the execution state of the tasks through the working group.

5. The method of structuring information of claim 4, further comprises a step: sending notifications to the members responsible for the tasks automatically, the notifications indicate the deadline of the tasks, and the messages are sent out before a given time of the deadline.

6. The method of structuring information of claim 4, further comprises a step: sending notifications to the members responsible for the tasks automatically when the tasks are completed.

7. The method of structuring information of claim 1, further comprises a step: adding and deleting the number of members of the working group by administrator.

8. The method of structuring information of claim 1, further comprises a step: administrator may carry out the task assignment and progress control to the members of the working group through an assist list.

9. A system of structuring information, computed on a data processing equipment and adapted for structuring communication information to form a plurality of working groups which composed of many members, the system comprising:
an information-transmitting module, for transmitting and receiving a plurality of message;
an information-retrieving module, for retrieving a plurality of message comply with a specific rule;
an information-switching module, for integrate the messages into the working group;
an time-counting module, for process and analysis the deadline control of the specific messages of the working group;
an information-recording module, for process and analysis the execution state of the specific message of the working group; and
an alerting module, for sending notification to the members responsible for the specific message automatically, the notifications indicate the deadline of the tasks, and the messages be sent out before a given time of the deadline.

10. The system of structuring information of claim 9, further comprises a system administrator module, wherein the system comprising:
an authority setter, for providing the members with access authority of the message and providing at least one of third party with authority to only read the messages; and
a project revising device, for carrying out the task assignment and progress control to the members.

11. The system of structuring information of claim 9, wherein the data processing equipment may be personal computer or application server, and the data processing equipment comprises an enterprise resource planning system, a memory, a display device and a processor.

12. The system of structuring information of claim 9, wherein the messages contains at least one title and content respectively, the title and the content are associated, the members may parallel browsing the task assignment and progress tracking of the messages.

13. The system of structuring information of claim 9, wherein the complete schedule of the messages of the working group are depict by using Gantt chart by the time-counting module.

14. The system of structuring information of claim 9, wherein the execution state comprise ongoing, completed and finished.

15. The system of structuring information of claim 14, wherein system may send notifications to the members responsible for the tasks automatically when the tasks are completed.

16. The system of structuring information of claim 10, wherein the project revising device is for adding and deleting the number of members of the working group.
